(19) United States
(12) Patent Application Publication
(10) Pub. No.: US 2015/0328645 A1
(43) Pub. Date: Nov. 19, 2015

(54) Method for separating calcium carbonate and gypsum

(71) Applicants: SOLVAY SA, Brussels (BE); CENTRE NATIONAL DE LA RECHERCHE SCIENTIFIQUE, Paris Cedex 16 (FR); UNIVERSITE DE LORRAINE, Nancy Cedex (FR)

(72) Inventors: Lev Leon FILIPPOV, Nancy (FR); Inna KUVAEVA FILIPPOV, Nancy (FR); Jean-Marie Michel HOTTIER, Dombasle sur Meurthe (FR)

(21) Appl. No.: 14/652,963

(22) PCT Filed: Dec. 18, 2013
(86) PCT No.: PCT/EP2013/077062

§ 371 Date: Jun. 17, 2015

(30) Foreign Application Priority Data
Dec. 19, 2012 (FR) 1262309

(51) Int. Cl. B03D 1/02; B03D 1/012; B03D 1/014; B03D 1/006

(52) U.S. Cl. CPC B03D 1/02; B03D 1/006; B03D 1/012; B03D 1/014

(57) ABSTRACT

A method for separating a suspension containing gypsum granules and calcium carbonate granules and an aqueous solution, wherein the aqueous solution comprises at least one sodium salt, wherein the aqueous solution has a sodium ion concentration of at least 3 g/L and wherein such method comprises a step of separation by flotation using a collector for the gypsum granules, the collector comprising at least one heteropolar organic surfactant of formula RX, in which: R denotes a hydrocarbon-based chain comprising from 2 to 50 carbon atoms, and the hydrocarbon-based chain is chosen from: a saturated or unsaturated linear alkyl chain, a saturated or unsaturated branched alkyl chain; and X denotes at least one ionizable group selected from the group consisting of: a carboxylic group, a sulfonate group, a sulfate group, a phosphonate group, a phosphate group, and a hydroxamate group.

### TECHNICAL FIELD

The present patent application claims the priority of French patent application No. 1262309, filed on Dec. 19, 2012, the entire contents of which are incorporated herein by reference for all relevant purposes.

The invention relates to a method for separating a suspension containing gypsum granules and calcium carbonate granules and an aqueous solution comprising at least one sodium salt, said method comprising a step of separation by flotation using a collector for the gypsum granules of heteropolar organic surfactant type. The invention also relates to the use of calcium carbonate granules or gypsum granules treated according to the method of the present invention, in cement works, or in civil engineering.

Specifically, in many processes, calcium carbonate and gypsum (calcium sulfate dihydrate) granules are generated and are found in suspension as a mixture. It is difficult to upgrade these mixtures, for example in civil engineering, due to the difference in the type of possible uses for each of the minerals.

Calcium carbonate is often used as an inert filler in cements or concretes as a result of its low solubility in water; for example, the solubility product of calcite in water is Kₛ=10^{-8.3} (mol/L)². The other crystalline species of calcium carbonate, such as aragonite or vaterite, which are less common in nature, have slightly different but similar solubility products.

Calcium sulfate is more soluble in water: about 0.2 g of CaSO₄ per 100 g of H₂O, and its solubility increases up to a factor of the order of two in saline solution. Calcium sulfate is a setting modifier in cements and concretes. It is capable of causing swelling and embrittlement of construction materials by delayed formation of ettringite if it is used in large amount. However, gypsum is a good starting material for making construction materials such as plaster boards or slabs, especially after calcination to transform it into calcium sulfate hemihydrate, which has hydraulic setting properties when it is placed in contact with water.

Although chemically different as regards the constitution of their anion, calcium carbonate and calcium sulfate nevertheless have relatively similar physical properties (density, dielectric or magnetic susceptibility), which renders difficult the low-cost separation of large volumes of such mixtures, especially when calcium carbonate and gypsum are both in the form of small particles or granules.

### TECHNICAL BACKGROUND

Among the techniques for separating minerals, flotation is one of the techniques employed, especially in ore enrichment. Flotation allows the separation of solid particles or granules by exploiting the differences existing between their surface properties in an aqueous solution.

The principle of flotation (cf. Encyclopédie de l'Ingénieur, Edition Lavoisier, Paris, Vol. J3350, pages 1 to 2, June 2012) is as follows: the solid granules are suspended in a liquid, generally water, after more or less thorough optional grinding. This solid-water mixture, also known as a pulp, is conditioned with a chemical reagent known as a collector, whose role is to render hydrophobic the surface of the mineral to be floated, so as to give it greater affinity for the gaseous phase than for the liquid phase. The pulp thus conditioned is placed in reactors equipped with aerated agitators (flotation cells) or air injectors (flotation column) or electrodes (electro-flotation) generating air bubbles and dispersing them. The granules rendered hydrophobic attach to the surface of the bubbles, which constitute a transport vector by virtue of their ascending movement to the free surface of the pulp. A solid-laden supernatant foam known as a froth is thus obtained. The size of the bubbles (and therein the liquid-air interfacial area) and the lifetime of the foam are modified by the optional addition of a foaming agent.

The entrained liquid is drained by gravity within the foam itself, which is collected by overflow. Froth and residual pulp are each generally subjected to a subsequent treatment such as optional washing, decantation and/or filtration, and optional drying, to collect floated solid granules as overflow and solid granules as underflow, depending on whether it is desired to use one or other of the solids obtained in wet or dry form.

Separation by flotation of soluble or partially soluble ores has been intensively studied, especially for the separation of nonferrous metal sulfides, metal oxides, phosphate ores, and sylvite (KCl).

It is known that sedimentary deposits of phosphate ores such as those of apatite Ca₅(PO₄)₃(F,OH) may be treated by flotation when the lode rock consists essentially of siliceous materials, such as the phosphate sandstone from central Florida. The flotation of apatite ore then makes it possible to separate with the froth the apatite ore and the carbonate, and as underflow in the residual pulp to remove quartz and silica. Sedimentary phosphates with a high carbonate content, for example those from southern Florida and from the Mediterranean area, do not, however, lend themselves to flotation (H. Sis, S. Chander/Minerals Engineering vol. 16 (2003) pp. 577-585).

The separation of mixtures of calcium carbonate and sulfate ores has been the subject of little development. The presence of calcium ions (Ca²⁺) in large amount in aqueous solution originating from the partial dissolution of gypsum provides a negative prejudice to the use of ionic surfactants. Specifically, alkaline-earth metal ions (Mg²⁺, Ca²⁺, etc.) react with ionic surfactants to form the corresponding calcium or magnesium salts, which are insoluble and inhibit their power for lowering the solution-air surface tension, which especially prevents the formation of a stable foam. Thus, in the field of detergency, especially for washing machines and dishwashers, it is common practice to complex (by using phosphates, polyphosphonates or citrates) or to precipitate (with zeolites, or builders such as sodium carbonate) the ions Mg²⁺ or Ca²⁺ from the water used so as to make it “less hard”. This makes it possible to conserve the efficacy of the surfactants so that they can produce the desired effects.

However, the need to separate gypsum from calcium carbonate remains, in order to broaden the possibilities of upgrading of such mixtures, especially in the fields of cement works and civil engineering and to allow sustainable development of such upgrading industries.

### SUMMARY OF THE INVENTION

It has been found, surprisingly, that:
ionic surfactants bearing one or more carboxylic, sulfonate, sulfate, phosphonate, phosphate or hydroxamate groups constitute an efficient collector for separating gypsum granules in a suspension containing gypsum granules and calcium carbonate granules in aqueous solution when this solution comprises at least one sodium salt with a sodium ion concentration of at least about 3 g/L,
nonionic surfactants of the polarizable alcohol type and especially of the Guerbet alcohol type do not constitute an efficient collector for separating gypsum granules in a suspension containing gypsum granules and carbonate granules when they are used alone, but can do so when they are combined with the ionic surfactants mentioned above.

Consequently, the present invention relates to a method for separating a suspension containing gypsum granules and calcium carbonate granules and an aqueous solution, characterized in that the aqueous solution comprises at least one sodium salt and in that the aqueous solution has a sodium ion concentration of at least about 3 g/L, preferably at least about 10 g/L and preferentially at least about 30 g/L and in that said method comprises a step of separation by flotation using a collector for the gypsum granules, the collector comprising at least one heteropolar organic surfactant of formula RX, in which:
R denotes a hydrocarbon-based chain comprising from 2 to 50 carbon atoms, preferably from 10 to 30 carbon atoms and preferentially from 15 to 25 carbon atoms, and the hydrocarbon-based chain is chosen from: a saturated or unsaturated linear alkyl chain, a saturated or unsaturated branched alkyl chain,
X denotes at least one ionizable group chosen from the group consisting of: a carboxylic group, a sulfonate group, a sulfate group, a phosphonate group, a phosphate group, or a hydroxamate group.

A first advantage of the present invention is the selectivity obtained on the separation of gypsum granules from a pulp consisting of a mixture of gypsum granules and calcium carbonate granules.

A second advantage of the present invention is the good selectivity of the gypsum collectors even in the presence of a high ionic strength and/or a high calcium content of the solution of the pulp to be treated.

A third advantage of the present invention is the simplicity with which the granules of the two calcium minerals may be separated into two enriched upgradable phases, especially in the fields of cement works and civil engineering.

A fourth advantage of the present invention in the case where the suspension containing gypsum granules and calcium carbonate granules is obtained by adding milk of lime to a saline solution comprising sulfate ions, followed by carbonatation of all or part of the milk of lime with carbon dioxide, is that it allows the separation of sulfates in the form of gypsum granules from calcium carbonate granules, by using carbon dioxide at low concentration, and thus allows a reduction of the CO₂ footprint of processes incorporating these steps.

### DEFINITIONS

In the present document, the following definitions apply:
“granule”: a particle of a solid,
“gypsum granule”: a particle of a solid generally comprising at least 80% and preferably at least 90% by weight of calcium sulfate dihydrate (CaSO₄.2H₂O),
“calcium carbonate granule”: a particle of a solid generally comprising at least 80% and preferably at least 90% by weight of calcium carbonate (CaCO₃), generally present in the form of calcite,
“sodium salt”: a sodium salt that is partially soluble in the aqueous solution, such as sodium borate, sodium chloride, sodium sulfate, sodium sulfite, sodium nitrate, sodium nitrite, advantageously sodium chloride or sulfate, more advantageously sodium chloride,
“collector”: a chemical reagent that renders hydrophobic the surface of the granules, thereby increasing the affinity of the granule for the gaseous phase used in flotation,
“pulp”: a suspension of solid granules in an aqueous solution,
“froth”, also known as “foam” or “floated material” or “overflow”: a supernatant foam obtained as the overflow from a flotation device,
“residual pulp”, also known as “sterile material” or “non-floated material” or “underflow”: a pulp obtained as the underflow from a flotation device after a flotation operation,
“hydrocarbon-based chain”: an organic chain comprising carbon and hydrogen atoms and optionally one or more other atoms such as oxygen (O), sulfur (S), nitrogen (N) or phosphorus (P),
“ionizable group X”: a hydrogenated group or group bearing an alkali metal such as lithium, sodium, potassium, etc., preferably sodium or potassium, preferentially sodium, which is capable of losing the hydrogen or the corresponding alkali metal in the form of H+, Li+, Na+, K+, etc. ions,
“at least one ionizable group chosen from the group consisting of: a carboxylic group a sulfonate group, a sulfate group, a phosphonate group, a phosphate group, a hydroxamate group”: at least one carboxylic group (—COOH or —COOM with M being one of the alkali metals listed in the preceding paragraph), or at least one sulfonate group (—SO₂—OH or —SO₂—OM with M being one of the alkali metals listed in the preceding paragraph), or at least one sulfate group (—O—SO₂—OH or —O—SO₂—OM with M being one of the alkali metals listed in the preceding paragraph), or a phosphonate group (—PO—(OH)₂ or —PO—(OM)₂ with M being one of the alkali metals listed in the preceding paragraph), or a phosphate group (—O—PO—(OH)₂ or —O—PO—(OM)₂ with M being one of the alkali metals listed in the preceding paragraph), or a hydroxamate group (—CO—NH—OH or —CO—NH—OM with M being one of the alkali metals listed in the preceding paragraph), present on the hydrocarbon-based chain, either as the sole ionizable group of the hydrocarbon-based chain, or in the form of several ionizable groups of the same nature (for example in the form of a polycarboxylic or polysulfonate or polysulfate or polyphosphonate or polyphosphate or polyhydroxamate surfactant) or in the form of several groups of different nature.

In the present specification, the choice of an element from a group of elements also explicitly describes:
the choice of two or the choice of several elements from the group,
the choice of an element from a subgroup of elements consisting of the group of elements from which one or more elements have been removed.

In the present specification, the description of a range of values for a variable, defined by a bottom limit, or a top limit, or by a bottom limit and a top limit, also comprises the embodiments in which the variable is chosen, respectively, within the value range: excluding the bottom limit, or excluding the top limit, or excluding the bottom limit and the top limit.

The term “comprising” includes “consisting essentially of” and also “consisting of”.

The use of “one” or “a(n)” in the singular also comprises the plural, and vice versa, unless otherwise indicated.

If the term “about” is used before a quantitative value, this corresponds to a variation of ±10% of the nominal quantitative value, unless otherwise indicated.

### BRIEF DESCRIPTION OF THE DRAWINGS

FIG. 1 is a block diagram of one of the embodiments of the invention using a flotation cell 3.

FIG. 2 is a block diagram of one of the embodiments of the invention using a flotation cell 3, and of the complementary liquid-solid separation equipment such as decanters 6 and 13 and filters 10 and 17.

FIG. 3 is a block diagram of one of the embodiments of the invention using a flotation cell 3, and of the complementary liquid-solid separation equipment such as decanters 6 and 13 and filters 10 and 17, and contact reactors 23 and 26.

FIG. 4 illustrates the mass percentage (%) of recovery, noted “recovery (%)”, of gypsum, calcium carbonate and apatite granules after flotation tests, at three concentrations of sodium oleate added to the flotation cell, described in Example 1.

### DETAILED DESCRIPTION OF THE INVENTION

The present invention relates to a method for separating a suspension containing gypsum granules and calcium carbonate granules and an aqueous solution, characterized in that the aqueous solution comprises at least one sodium salt and in that the aqueous solution has a sodium ion concentration of at least about 3 g/L, preferably at least about 10 g/L and preferentially at least about 30 g/L and in that said method comprises a step of separation by flotation using a collector for the gypsum granules, the collector comprising at least one heteropolar organic surfactant of formula RX, in which:
R denotes a hydrocarbon-based chain comprising from 2 to 50 carbon atoms, preferably from 10 to 30 carbon atoms and preferentially from 15 to 25 carbon atoms, and the hydrocarbon-based chain is chosen from: a saturated or unsaturated linear alkyl chain, a saturated or unsaturated branched alkyl chain,
X denotes at least one ionizable group chosen from the group consisting of: a carboxylic group, a sulfonate group, a sulfate group, a phosphonate group, a phosphate group, or a hydroxamate group.

Specifically, the inventors have observed that these types of specific heteropolar organic surfactants have comparable affinity for gypsum and calcium carbonate granules when these minerals are in suspension in water; but that, on the other hand, they are particularly effective for the selective flotation of gypsum granules when these granules are present in a suspension containing gypsum granules and calcium carbonate granules and an aqueous solution of high ionic strength in the presence of sodium ions or sodium and calcium ions. Nonionic surfactants of the polarizable alcohol type and especially of the type such as Guerbet alcohols, which are generally sparingly influenced by the presence of sodium ions or sodium and calcium ions, showed no efficacy for the separation of gypsum and calcium carbonate granules when they are used alone, but, on the other hand, these nonionic surfactants improve the selectivity of the separation of the two minerals when they are combined with the ionic surfactants mentioned above.

In the present specification, the term “selective flotation” means a step of separation by flotation of a pulp, for obtaining a froth as overflow generally containing at least 60%, advantageously 70%, preferentially at least 80% and more preferably at least 85% by weight of the gypsum granules of the initial pulp and, for each of these cases, generally less than 40%, or less than 30%, or less than 20% by weight of the calcium carbonate granules of the initial pulp.

Preferably, the surfactant of heteropolar organic type RX is chosen from the group consisting of: a sodium or potassium oleate, a sodium or potassium alkylsulfonate, a sodium or potassium alkyl sulfate, a sodium or potassium sulfosuccinamate, or a mixture thereof, preferably a sodium or potassium oleate. The collector may also comprise a nonionic surfactant such as an isoalcohol or a Guerbet alcohol.

In the present invention, the step of separation by flotation is performed with a flotation cell that is well known to those skilled in the art, of the type with mechanical stirring or of pneumatic type such as a flotation column. Such flotation cells are described, for example, in the encyclopaedia Les techniques de l'Ingénieur—Volume J3360 pages 1 to 22, flottation aspects pratiques [Practical aspects of flotation]—Paris, June 2012, which is incorporated by reference into the present description.

In such a flotation cell, the pulp, a suspension of granules in the aqueous solution, is placed in contact with air bubbles. In the case of flotation of pneumatic type using a counter-current column, the pulp is injected into the column from the top and is recovered at the bottom, circulating in descending manner through the column, while the bubbles, formed in a bubble generator at the bottom, rise. Gas and aqueous solution meet and the hydrophobic granules stick to the bubbles in a zone of the column known as the “collection zone”. Once they have arrived at the surface, the bubbles form a foam, or froth, which is stable enough for its amount to increase continually and for it to be able to be recovered by overflow at the top of the column. This froth is thus charged with granules selectively collected by the bubbles and constitutes one of the two flotation products (“floated” product or “froth”).

The product recovered by a pumping system at the bottom of the column constitutes the “non-floated material” or “sterile material”. It corresponds to the aqueous solution freed of the particles specifically collected by the bubbles. It may also contain hydrophilic particles that are not stuck to the bubbles.

The flotation cells with mechanical stirring function in a similar manner, but the pulp is introduced by mechanical suction under the effect of the rotor at the intermediate part of the cell, the froth is collected at the top part and the residual aqueous solution and the “non-floated material” are recovered at the bottom part of the flotation cells.

In the present invention, the heteropolar organic surfactant collector is introduced directly into the flotation cell close to the bubble generator. This makes it possible to limit the consumption of the collector by the calcium ions in the liquid phase and allows better adsorption on the surface of the calcic gypsum granules. The collector may also be introduced directly into the flotation column at the pulp-foam interface, for example, such that the collector is adsorbed on the mineral surface in the descending flow.

In order for the partition of the gypsum and calcium carbonate granules with such surfactants to be efficient, it is desirable for the calcium carbonate granules and the gypsum granules to have a particle size distribution such that at least 90% by weight of the particles have a diameter of less than 150 μm, preferably less than 130 μm, preferentially less than 110 μm and more preferably less than 90 μm. In general, the calcium carbonate granules and the gypsum granules have a particle size distribution such that at least 10% by weight of particles have a diameter of greater than 0.1 μm, preferably greater than 1 μm and preferentially greater than 2 μm. The amount of gypsum granules or of calcium carbonate granules reported per unit volume of suspension (the pulp) is generally at least 10 kg/m³ and advantageously at least 15 kg/m³. It is generally not more than 75 kg/m³ and advantageously not more than 50 kg/m³. The weight ratio between gypsum granules and calcium carbonate granules of the suspension is generally between 1:3 and 3:1 and advantageously between 1:2 and 2:1.

The surfactants mentioned above may function over a wide pH range. Excessively acidic pH values of the suspension below 5 give rise to acid attack of the calcium carbonate granules, generating CO₂. This evolution of CO₂ at excessively acidic pH values is harmful to good selectivity: the reason for this is that the carbonate granules then become covered with CO₂ microbubbles, which has the effect of entraining the calcium carbonate granules in an ascending stream and of reducing the selectivity of separation of the gypsum granules and of the calcium carbonate granules of the suspension. In general, in the present invention, the suspension has a pH of at least 5, preferably of at least 7, preferentially of at least 7.5 and more preferentially of at least 8.

Moreover, at a very high pH above 13, hydroxyl complexes Ca(OH)⁺ bind to the heteropolar organic surfactants, reducing their efficacy. In the present invention, the suspension has a pH advantageously not above 13, more advantageously not above 11 and even more advantageously not above 10.

In the method according to the invention, the suspension containing gypsum granules and calcium carbonate granules and an aqueous solution may be obtained, for example, by:
a) adding milk of lime to a saline solution comprising at least 0.5 g of sulfate ions per liter, and
b) carbonatation of all or part of the milk of lime with carbon dioxide.

In the method according to the invention, the suspension containing gypsum granules and calcium carbonate granules present in the aqueous solution may also be obtained by reaction of a milk of lime comprising at least one sodium salt, or of a mixture of milk of lime and of a calcium carbonate brew comprising at least one sodium salt with acidic fumes derived from the combustion of a sulfurous organic compound such as a charcoal, a lignite, a wood, an agricultural residue, an organic residue of the food industry, an organic residue of the paper industry, a sludge from a drinking water or waste water purification plant, or an organic sludge from a biogas production unit.

The surfactants mentioned above also proved to be effective for separating gypsum granules and calcium carbonate granules in aqueous solutions with a high content of soluble salts, especially sodium salt. This is particularly advantageous, for example, for residual solutions from the washing of acidic gases such as SOₓ (SO₂, SO₃, etc.) performed with seawater or brines by means of ground calcium carbonate and/or LCH, or with permeates concentrated in sodium ions originating from a plant for seawater desalination by evaporation, by dialysis or by reverse osmosis.

During the reaction of the calcium ions originating from calcium carbonate or originating from milk of lime reacting with acidic gases such as SOₓ or with sulfate ions from seawater, or from optionally concentrated seawater, or with acidic brines from the washing of equipment using hydrochloric acid (HCl), the calcium ions content is liable to reach significantly higher values than the solubility values of gypsum in water. In the case of a high concentration value of calcium ions, and optionally a high value of sodium ions, solubility of the sulfate ions will fall in a manner inversely proportional to the calcium ion concentration, governed by the solubility product of gypsum and the corresponding activity coefficients.

The surfactants listed in the present invention proved, in this case also, surprisingly, to be a good collector of gypsum granules for the separation of a suspension containing gypsum and calcium carbonate granules in such brines. Consequently, the present invention also relates to a method for separating gypsum granules and calcium carbonate granules in an aqueous solution, according to which the aqueous solution also comprises at least one calcium salt, and in that the aqueous solution has a calcium ion concentration of at least about 0.5 g/L, preferably at least about 5 g/L and preferentially at least about 10 g/L.

The term “calcium salt” means a calcium salt that is partially soluble in the aqueous solution, such as calcium hydroxide, calcium chloride, calcium nitrate or calcium nitrite, advantageously calcium chloride.

The calcium salt(s) may be present in combination with the sodium salt(s). Separations of gypsum and calcium carbonate granules in mixed saline solutions of sodium and calcium salts with a concentration of soluble salts of up to about 4 mol of sodium and/or calcium per litre also give excellent separation results for the two types of granules according to the present invention.

In a particularly advantageous embodiment of the present invention, the gas used for the flotation is a gas whose carbon dioxide (CO₂) content is less than 10%, preferably less than 1% and more preferably less than 0.5% by volume of this dry gas.

A flotation performed with a gas composed of air enriched with 15-25 vol % of CO₂ gives, as regards the floated solid, correct gypsum separation yields, of the order of 70%, but reduced selectivity toward carbonates. With a gas having a CO₂ concentration of between 15 and 25 vol %, the separation yields for the carbonates in the floated material are of the order of 35%. On the other hand, the use of a gas such as air or an inert gas such as nitrogen, whose CO₂ contents are limited, give improved separation and selectivity results according to the invention. Thus, with the same ionic and nonionic surfactants and similar operating conditions, a flotation gas composed of air or nitrogen makes it possible to obtain recovery yields in the froth (the floated material) of 71% to 88% yield of sulfate and 6% to 21% yield of carbonate corresponding to higher selectivity coefficients (selectivity of between 12 and 95).

Thus, in the case where the suspension containing gypsum granules and calcium carbonate granules is obtained either by adding milk of lime to a saline solution comprising at least 0.5 g of sulfate ions per liter, followed by carbonatation of all or part of the milk of lime with carbon dioxide, or by reaction of a milk of lime comprising at least one sodium salt, or of a mixture of milk of lime and of a calcium carbonate brew comprising at least one sodium salt with carbon dioxide or acidic fumes derived from the combustion of a sulfurous organic compound, the carbonatation step is preferably separate and prior to the flotation step. Moreover, the flotation step is preferably performed with a gas whose carbon dioxide content is limited according to the limits indicated above.

The feed rate of the pulp in a flotation cell may vary from 0 to a limit speed beyond which the bubbles are entrained with the calcium carbonate granules as an underflow. In the present invention, flotation cell feed rates that are suitable for use correspond to surface speeds in an empty tank Jₐ of at least 0.1, preferably at least 0.2 and preferentially at least 0.5 cm/s. The surface speed in an empty tank of the pulp feed rate corresponds to the volume rate per unit of time divided by the maximum working area of the horizontal section of the flotation cell. Advantageously, the flotation cell feed rates are chosen so that the surface speeds in an empty tank Jₐ are not more than 5.0, more advantageously not more than 3.0 and even more advantageously not more than 1.7 cm/s. Values of between 0.5 and 1.7 cm/s are particularly suitable for use.

The mean surface speed of gas in the part of the flotation cell in which the gas rises is generally at least 0.1, preferably at least 0.2 and preferentially at least 0.5 cm/s. The mean surface speed of gas in the part of the flotation cell in which the gas rises is advantageously not more than 5.0, more advantageously not more than 3.0 and even more advantageously not more than 1.7 cm/s. Most preferably, the mean surface speed of gas in the part of the flotation cell in which the gas rises is at least 0.5 and not more than 1.5 cm/s. The mean surface speed of gas in the part of the flotation cell in which the gas rises is defined as the volume rate of gas divided by the area of the mean horizontal section in the part of the flotation cell in which gas and pulp are in contact.

In a particular embodiment of the present invention, the step of separation by flotation is performed with a flotation cell of mechanical stirring type or of pneumatic type such as a flotation column and the mean surface speed of gas in the flotation cell is at least 0.1, preferably at least 0.2 and preferentially at least 0.5 cm/s and advantageously not more than 5.0, more advantageously not more than 3.0 and even more advantageously not more than 1.7 cm/s, and most preferably at least 0.5 and not more than 1.5 cm/s.

The dispersion of the gas in the flotation cell is chosen from the devices known in the art so as to generate in the flotation cell, in general, gas bubbles with a mean volume diameter generally of at least 0.4 mm, advantageously at least 0.6 mm, and more advantageously not more than 0.65 mm. The mean volume diameter of the bubbles is generally not more than 2.5 mm, advantageously not more than 1.2 mm and more advantageously not more than 1.0 mm. Mean volume diameters of the bubbles of at least 0.65 mm and not more than 0.95 mm are particularly suitable for use.

In the case where the production of gypsum granules and calcium carbonate granules in an aqueous solution is obtained by: a) adding milk of lime to a saline solution comprising at least 0.5 g of sulfate ions per liter, and b) carbonatation of all or part of the milk of lime with carbon dioxide.

It is particularly advantageous to inject sufficient carbon dioxide into the saline solution comprising the milk of lime so that the content of slaked lime (Ca(OH)₂) granules relative to the weight of the gypsum and calcium carbonate granules of the pulp is less than 5%, preferentially less than 3% and more preferentially less than 1% by weight. In general, to achieve such contents of slaked lime (Ca(OH)₂) granules relative to the weight of gypsum and calcium carbonate granules of the pulp, the carbonatation with carbon dioxide is performed at a pH of about 7, preferably of about 6.5, preferentially of about 6.0 and more preferentially of about 5.5. After the carbonatation, when the acidic carbon dioxide is no longer introduced into the mixture of granules, the pH of the mixture rises rapidly by about 0.1 to 2.5 pH units to reach pH values of between about 7.0 and about 9.5. This rise in pH is due to the presence of the granules of calcium carbonate, which is a mild alkali, and to the presence of residual slaked lime, which is alkaline. The more fully carbonated the lime, the closer the pH of the brew after the carbonatation approaches to neutrality.

This carbonatation may be performed with a carbon dioxide originating from fumes derived from the combustion of a sulfurous organic compound such as a charcoal, a lignite, a wood, an agricultural residue, an organic residue from the food industry, an organic residue from the paper industry, a sludge from a drinking water or waste water purification plant, or an organic sludge from a biogas production plant. In general, such fumes contain a carbon dioxide concentration by volume relative to the dry gas of at least 8%, or at least 10%. Said fumes generally comprise a carbon dioxide concentration by volume relative to the dry gas of not more than 20%, or not more than 18%.

In the case where the production of gypsum granules and calcium carbonate granules in an aqueous solution is obtained by: a) adding milk of lime to a saline solution comprising at least 0.5 g of sulfate ions per liter, and b) carbonatation of all or part of the milk of lime with carbon dioxide, or in the case where the mixture of gypsum and calcium carbonate granules is obtained by washing sulfurous fumes with a milk of lime, it is particularly advantageous to perform the carbonatation and the flotation in this order rather than in the reverse order or concomitantly. Specifically, it has been found that the flotation and the selectivity of flotation of gypsum and calcium carbonate granules with the surfactants described in the present specification are much better, all the parameters being otherwise constant, once the carbonatation is performed. Flotation concomitant with carbonatation, namely flotation with a gas or combustion fumes containing carbon dioxide CO₂ according to the method of the present invention also gives markedly lower efficacy and flotation selectivity when compared with those obtained when the carbonatation of any lime granules is performed before the flotation.

The present invention thus makes it possible to separate a mixture of gypsum granules and calcium carbonate granules present in an aqueous solution into two phases enriched, respectively:

in gypsum, as an overflow of the flotation cell,

in calcium carbonate, as an underflow of the flotation cell.

These two phases enriched, respectively, in gypsum and calcium carbonate granules allow easier upgrading especially in the fields of cement works and civil engineering.

Thus, the present invention also relates to the use of calcium carbonate granules or gypsum granules derived from the method of the present invention: in cement works, or in civil engineering, or in road engineering, or for the manufacture of building materials, or the manufacture of plaster boards or slabs, or the manufacture of road granulates, or the manufacture of filling materials for filling underground cavities, or the desulfurization of fumes.

The examples that follow serve to illustrate the invention. They are not limiting.

FIG. 1 is a block diagram of one of the embodiments of the invention using a flotation cell 3. A suspension 1 containing gypsum granules and calcium carbonate granules and an aqueous sodium solution is introduced into the flotation cell 3. The heteropolar organic surfactant collector 2 is also introduced into the flotation cell 3. A phase 4 enriched in gypsum granules is collected as an overflow of the flotation cell 3. A phase 5 enriched in calcium carbonate granules is collected as an underflow of the flotation cell 3.

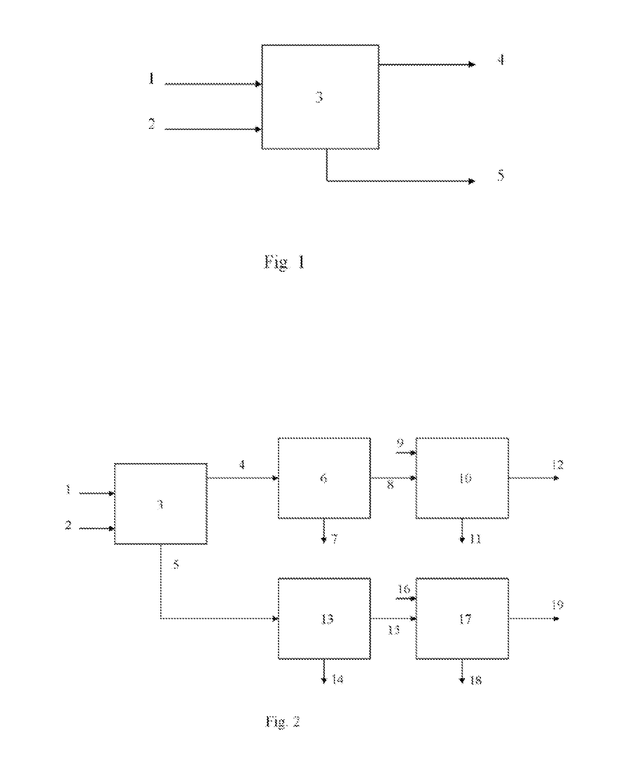

FIG. 2 is a block diagram of one of the embodiments of the invention using a flotation cell 3, and complementary liquid-solid separation equipment such as decanters 6 and 13 and filters 10 and 17. A suspension 1 containing gypsum granules and calcium carbonate granules and an aqueous sodium solution is introduced into the flotation cell 3. The heteropolar organic surfactant collector 2 is also introduced into the flotation cell 3. A phase 4 enriched in gypsum granules is collected as an overflow of the flotation cell 3, and is optionally introduced diluted with water or mother liquors into a decanter, and optionally introduced with a flocculant and/or an antifoam into a decanter 6. The decantation water or the decantation mother liquors 7 are collected as an overflow of the decanter 6. A brew 8 enriched in gypsum granules is then introduced into a filter 10, and a washing water or washing mother liquors 9 is (are) optionally used on the filter 10 to wash the optionally washed granules of the brew 8. A filter cake 12 enriched in gypsum granules is collected from the filter 10, along with the filtration waters and optionally the washing waters 11 which are collected from the filter. Phase 5 enriched in calcium carbonate granules is collected as an underflow of the flotation cell 3. Phase 5 is introduced, optionally with a flocculant and/or an antifoam, into the decanter 13. The sodium-bearing decantation water or decantation mother liquors 14 are collected as an overflow of the decanter 13. A brew 15 enriched in calcium carbonate granules is then introduced into a filter 17, and a washing water or washing mother liquors 16 is (are) optionally used on the filter 17 to wash the granules of the brew 15. A filter cake 19 enriched in calcium carbonate granules is collected from the filter 10, along with the filtration waters and optionally the washing waters 18 which are collected from the filter 17. Optionally (not shown in FIG. 2), the filtration waters and optionally the washing waters 11 are recycled upstream of the decanter 6 to repulp phase 4 (froth) before introduction into the decanter 6, and thus to organize a counter-current for optimizing the water balance of the method according to the invention. This is likewise the case (not shown in FIG. 2) for the filtration waters and optionally the washing waters 18, which may optionally be recycled upstream of the decanter 13 to repulp phase 5 (underflow of the flotation cell 3) before introduction into the decanter 13, and thus to organize a counter-current for optimizing the water balance of the method according to the invention.

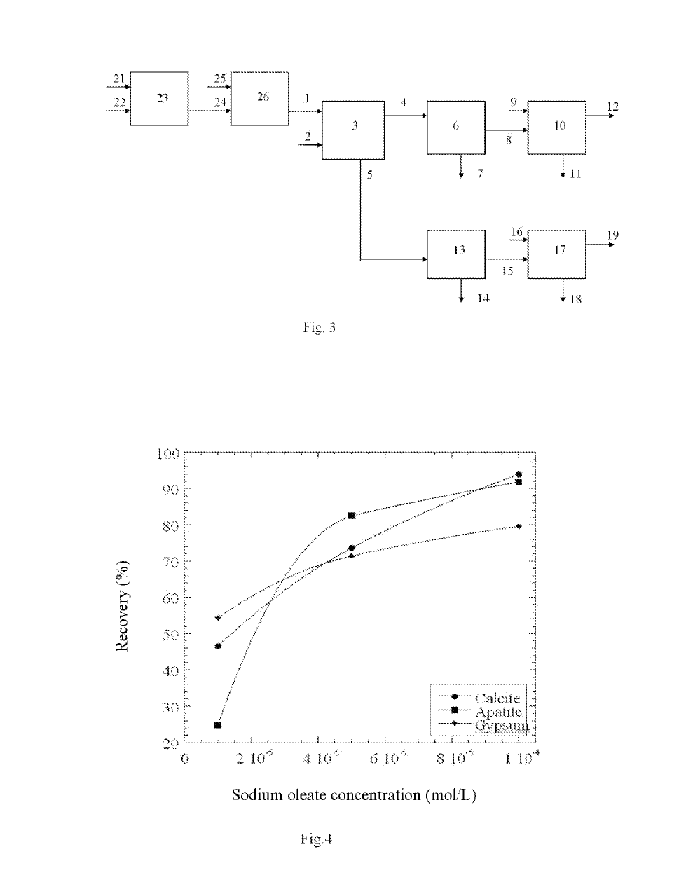

FIG. 3 is a block diagram of one of the embodiments of the invention using a flotation cell 3, complementary liquid-solid separation equipment such as decanters 6 and 13 and filters 10 and 17, and contact reactors 23 and 26. A saline solution 21 comprising at least 3 g of sodium ions per liter and 0.5 g of sulfate ions per liter is introduced into a contact reactor 23 with a milk of lime 22, forming gypsum granules in the contact reactor. The brew 24 obtained is then introduced into a contact reactor 26 with a gas 25 comprising carbon dioxide (CO₂) so as to carbonate the optional residual calcium hydroxide present in the brew 24 collected from the contact reactor 23 to form calcium carbonate granules. A suspension 1 containing gypsum granules and calcium carbonate granules and an aqueous suspension is then introduced into a flotation cell 3 for treatment according to one of the embodiments of the method of the present invention described in FIG. 2.

The examples that follow illustrate the invention without, however, limiting it.

### EXAMPLES

### Example 1

### Not in Accordance with the Invention

In a rectangular laboratory flotation cell, with a working volume of 185 mL and length×width×height dimensions equal to 65×65×114 mm, various tests were performed with gypsum granules (origin: Central Atlas, Idharen, Morocco), calcium carbonate granules (origin: Provence, France) and apatite granules (origin: Fort Dauphin, Tulear province, Madagascar) introduced alone into demineralized water) with various contents of heteropolar organic surfactant, the pH of which was adjusted by adding 1% solutions of NaOH or HCl. Stirring of the suspension in the cell was performed by a rotor developing a speed from 600 to 3000 rpm. The tests were performed with 3 g of the pure minerals mentioned above, with a particle size fraction of between 20 to 100 microns, with 175 ml of water.

A heteropolar organic surfactant: sodium oleate, was added to the suspension to be floated in three different amounts to obtain concentrations of 1·10⁻⁵, 5·10⁻⁵ and 10·10⁻⁵ (10⁻⁴) mol/L in the suspension to be floated.

The flotation cell was operated at a speed of 1750 rpm allowing air to be injected into the flotation cell for a period of 5 minutes.

The froth formed was collected and the amount by mass of gypsum or calcium carbonate or apatite granules was evaluated by comparison of the yields of the weights of minerals floated relative to the total weights of minerals introduced in each series of tests. To do this, the floated and non-floated products were dried in an oven at 80° C. and were then weighed to determine their weights, denoted, respectively, by Mf and Mnf. The mass recovery yield Rf of floated material was calculated according to the formula Rf=100×Mf/(Mf+Mnf).

FIG. 4 illustrates the mass percentage of recovery, noted “recovery (%)”, of gypsum, calcium carbonate and apatite granules after each of the flotation tests, for three concentrations of sodium oleate added to the flotation cell before the actual flotation operation.

It is found that the three minerals have similar floatability in the concentration range from 10⁻⁵ to 10⁻⁴ mol/L of surfactant. More particularly, the flotation behavior of gypsum and calcium carbonate is very similar over the surfactant concentration range tested, with very similar gypsum and calcium carbonate recovery yields for each of the surfactant concentrations, leading to the conclusion of poor selectivity of oleate for these two minerals when they are mixed in water.

### Example 2

### In Accordance with the Invention

The tests of Examples 2 to 5 were performed in two different pilot flotation columns with, however, a similar operating scheme and similar procedures. The tests were performed using a brine whose sodium content (in the form of dissolved sodium chloride) was at least 3 g/L and which could be up to 23 g/L (1 mol/L). The calcium content (in the form of dissolved gypsum and of soluble calcium chloride) was at least 0.5 g/L and could be up to 40 g/L (1 mol/L).

The first column used was 3.5 m long for a diameter of 75 mm, giving a feed rate of 0.01 to 0.5 m³/h. Various surfactant collectors were tested. The concentrations of the collectors and additives ranged from 0 to 100 ppm.

The second column used is an industrial pilot column 10 m long and 300 mm in diameter, which gives a feed rate of up to 5 m³/h. This second flotation column was only used with sodium oleate at concentrations ranging from 0.5 to 10 ppm. The test results on this second column were comparable to the results obtained on the first column under equivalent operating conditions (amount of floating agent, surface speeds of flotation air and pulp feed rate). The various points of introduction of the collector into the columns were tested starting with introduction directly into the bubble generator and two different levels of the column.

The surface speeds of gas and of feed were used instead of the rates to control the functioning of the column. The limits of these parameters were chosen in the following manner:
surface speed of ascending gases Jg: the minimum surface speed must ensure the formation of bubbles which will have an ascending movement in the column. The maximum value must not cause any formation of very large bubbles so as to avoid the entrainment of brine by a mechanical effect.
surface speed of descending feed: it may vary from 0 to a limit speed beyond which the bubbles are entrained with the sterile material (underflow).

The pulp feed rates in the present example were varied so as to obtain surface speeds of descending pulp of between 0.5 cm to 1.7 cm/s.

The air feed rates were adjusted to obtain surface speeds of ascending gases J_{g} of between 0.5 to 1.9 cm/s.

The weight yields of solids (granules) collected in each of the phases have been indicated for each test condition: i.e. the percentage ratio between that which was recovered in the foam (“foam” or “froth” or “floated material”) and the total amount sampled at the various outlets of the column: foam+sterile material, the whole within an identical time period. The water yields have the same definition as that of the solids, namely: ratio between the weight of water in the foam and the sum of the weights of water in the foam plus that of the sterile material. The weight of water of the floated phase is obtained by difference from the weight of the floated phase from which is subtracted the weight of the gypsum and calcium carbonate granules and the weight of the dissolved salts.

The material flows were thus calculated by timing of each sample collection and weighing of the samples collected, the flows component by component, also by means of the chemical analyses.

The sulfate analysis for the determination of the efficacy of gypsum separation between the floated phase and the non-floated phase is performed by acidic dissolution of the solids followed by gravimetry of the sulfate by precipitation of BaSO₄ with BaCl₂.

The carbonate analysis for the determination of the efficacy of calcium carbonate separation between the floated phase and the non-floated phase was performed on the solids that were filtered (floated and sterile material), and dried in an oven at 80° C. and then ground. The carbonate analysis was performed by gravimetry of the CO₂ contained in the solids via a standard measurement of CAA type (carbonate analysis by absorption). The solids are attacked with concentrated (9N) hydrochloric acid. Acid attack to the point of the color change of methyl orange (helianthin) of the carbonated compounds causes the evolution of CO₂, which is absorbed in a saturated solution of barium hydroxide (Ba(OH)₂) filtered beforehand at room temperature. The absorbed CO₂ precipitates in the clear barium hydroxide solution in the form of insoluble barium carbonate (BaCO³). The precipitated BaCO₃ is then quantified by gravimetry.

The calculation examples below are given for the sulfates.

The mass of dry matter in the floated and non-floated material is calculated according to:

$$MS = \frac{( 1 - humidity ) \times ( mass cake )}{( mass cake ) + ( mass filtrate )} \times 100$$

The calculation of the flow of SO₄²⁻ in the same products is performed from determination of the sulfate content y_{SO}_{₄}^{p}:

$${Φ}_{{SO}_{4}^{2 -}} = \frac{{y}_{{SO}_{4}}^{p} \times Ms}{{t}_{set}}$$

in which tₛₑₜ=setting time of samples
and p=foam (froth) or sterile materials (underflow).

The calculation of the recovery of SO₄²⁻ in the foam is calculated by considering the balance for the separation operation:

$${Rdtso}_{4}^{2 -} = \frac{Φ {{so}_{4}^{2 -}}_{foam}}{{{Φso}_{4}^{2 -}}_{foam} + {{Φso}_{4}^{2 -}}_{sterile}} \times 100$$

The yield thus clearly indicates the part recovered in the foam even when the carbonate yield is referred to. The yield of sulfates in the sterile materials is calculated according to the formula below, but taking the flow of sulfates in the sterile materials Φ_{SO}_{₄}_{^{2−}}ₛₜₑᵣᵢₗₑ. The carbonate yields are calculated in the same manner.

The selectivity S of the separation process by flotation is calculated from the chemical analyses performed and the contents y of carbonates and sulfates in the foams and the sterile materials according to the following formula:

$$S = \frac{{y}_{{SO}_{4}}^{foam} \cdot {y}_{{CO}_{3}}^{steriles}}{{y}_{{SO}_{4}}^{steriles} \cdot {y}_{{CO}_{3}}^{foam}}$$

Table 1 gives the results for Example 2 on column 1, 75 mm in diameter, separation tests performed with a surfactant of sodium oleate type at a concentration of 20 ppm.

The following are indicated in Table 1:
the water yield of the floated phase,
the weight percentage of the two collected phases, the floated phase (froth) and the non-floated phase (underflow), and normalized by the sum of the two collected phases,
the carbonate and sulfate content by chemical analysis of each of the two phases, floated and non-floated,
the calculation of the recovery balance for the gypsum and carbonate granules calculated from the chemical analyses.

The results of table 1 show that, independently of the pH (between 7 and 11) and of the flow rate of the pulp, the flotation allows a selective separation of the gypsum and calcium carbonate granules as demonstrated by the increase in the SO₄ content and a decrease in the CO₃ content in the floated product (froth). Conversely, the non-floated product (underflow) is enriched in CO₃ with a very significant decrease in sulfate content.

Test 2.3 reproduced in test 2.5 gives an idea of the repeatability of the tests.

### Examples 3 and 4

### In Accordance with the Invention

In the same column 1 with the same pulp and the same aqueous solution as in Example 2, the following surfactants (“collectors”) were tested:
sodium oleate (C₁₇H₃₃COO⁻+Na⁺)
sodium laurate (C₁₂H₂₃COO⁻+Na⁺)
alkyl sulfate (R—SO₄²⁻): Flotinor S 072 (Clariant)
alkyl sulfate (R—SO₄²⁻): pure dodecyl sulfate
alkyl sulfonate (R—SO₃⁻): Aero 830 Promoter (Cytec)
sulfosuccinamate: Aero 845N (Cytec) composed of tetrasodium N-(1,2-dicarboxyethyl-n octadecyl sulfosuccinamate, bearing three carboxylic groups and one sulfonate group
modified sulfosuccinamate: Procol CA540 (Allied Colloid Ltd) composed of tetrasodium N-(3-carboxylato-1-oxo-3-sulfonatopropyl)-N-octadecyl-DL-aspartate
nonionic surfactants of Guerbet alcohol type containing 12 or 16 carbon atoms: Isofol 12, noted ISF12 and Isofol 16, noted ISF 16 (Sasol Olefins & Surfactants).

Table 2 (Example 3) collates tests of ionic surfactant collectors used alone, of carboxylic type (sodium oleate and laurate), of alkyl sulfate type (dodecyl sulfates) and of mixed carboxylic and sulfonate type (sulfosuccinamate).

Table 3 (Example 4) collates tests of collectors of ionic surfactant type used in combination with anionic surfactants or with nonionic surfactants, always in a 1/1 mass proportion for each collector.

Tables 2 and 3 indicate:
the pulp feed rates expressed as speed in empty tank Ja,
the feed rates of flotation gas expressed as speed of gases in empty tank Jg,
the nature and concentration of surfactant collector(s) relative to the feed pulp,
the point of introduction of the collector into the flotation column (pump: on the pump for recycling the pulp into the column and in which the flotation gas is introduced, top CL: top of column: between the foam-pulp interface and the pulp feed point),
the percentage recovery of calcium carbonate and of gypsum in the froth,
the selectivity S of the gypsum collected relative to the calcium carbonate,
the mean diameter of the bubbles during the test.

The results of Table 2 show that:
without a surfactant collector, the high ionic strength of the solution already allows by flotation a calcite/gypsum separation in non-negligible yields,
among the collectors used, sodium oleate at concentrations of 0.8 to 11.8 ppm results in the best performance qualities in terms of yields of sulfates (from 76% to 94%) and of separation selectivity (12.7 to 95.2). These variations in concentration combined with the gas and pulp flow rates make it possible to obtain either a very high degree of removal of the sulfates (from 90% to 94%) for surface gas speeds ranging from 0.54 to 0.8 cm/s at a constant feed rate (1.13 cm/s), or a very high selectivity with an increase in the surface speed of the pulp tested of up to 1.26 cm/s,
the other anionic collectors, although showing satisfactory performance, give for sulfosuccinamate (Procol CA540) a high sulfate yield of 90%, but lower selectivity: 4.7,
sodium dodecyl sulfate shows a slightly lower gypsum separation yield, 72-76%, and a selectivity lower than that obtained with sodium oleate,
the consumption of these collectors, ranging from 5.8 to 11.8 ppm for dodecyl sulfate, from 22 to 60 ppm for sulfosuccinamate, is also higher than with sodium oleate, the optimum results for which are obtained with consumptions of between 0.8 and 3.0 ppm.

The addition of a nonionic reagent (ISF12, number of carbon atoms=12) to the column with sodium laurate promotes an increase in the sulfate yield without substantially modifying the carbonate floatability, giving a selectivity which passes from 32.5 for laurate alone to 53.5 with the mixture.

The same nonionic reagent was tested with sodium oleate again in a 1/1 proportion for a total collector consumption ranging from 2.8 to 30 ppm. The separation results show good selectivity, but the sulfate yields are low relative to oleate used alone.

An increase in the chain length of the nonionic additive from 12 to 16 carbon atoms reduces the selectivity for a total consumption of 11 ppm. However, a decrease in the consumption of the mixture from 11 to 3 ppm leads to the production of a floated product consisting virtually only of sulfates. The carbonate yield is only 2.8% for a sulfate yield of 55%.

### Example 5

### Not in Accordance

Various nonionic reagents such as isoalcohols and Guerbet alcohols were tested, along with a cationic collector, Cataflot from CECA (primary amine of chain length C16-C18 in the form of a chloride salt forming a positive ion in aqueous solution), under conditions similar to those of Examples 3 and 4.

These surfactants gave poor results on the same mixtures of granules and did not make it possible to separate the gypsum granules from the calcium carbonate granules.

TABLE 1
Example 2 - examples of flotation tests at various pulp feed rates:

| | | | | | Analysis of the | | | |
|---|---|---|---|---|---|---|---|---|
| | | | | | mixture of granules | | | |
| | Flow rate | | Water | Weight | Contents g/kg | | % Recovery | |
| Test Ref. | L/min | Product | yield % | yield % | CO₃ | SO₄ | CO₃ | SO₄ |
| 2.1 | 0.87 | Floated material | 2.8 | 21.1 | 98.0 | 438.5 | 7 | 71 |
| | | Non-floated material | | 78.9 | 336.4 | 48.5 | 93 | 29 |
| | | Reconstituted | | 100.0 | 286.1 | 130.7 | 100 | 100 |
| 2.2 | 1.48 | Floated material | 2.3 | 26.2 | 106.7 | 441.7 | 10 | 76 |
| | | Non-floated material | | 73.8 | 323.1 | 48.7 | 90 | 24 |
| | | Feed | | 100.0 | 266.4 | 151.6 | 100 | 100 |
| 2.3 | 2.52 | Floated material | 2.8 | 27.2 | 105.9 | 458.7 | 12 | 70 |
| | | Non-floated material | | 72.9 | 301.6 | 73.2 | 88 | 30 |
| | | Feed | | 100.0 | 248.5 | 177.9 | 100 | 100 |
| 2.4 | 2.53 | Floated material | 2.4 | 22.2 | 95.9 | 487.8 | 7 | 72 |
| | | Non-floated material | | 77.8 | 390.9 | 53.6 | 93 | 28 |
| | | Feed | | 100.0 | 325.5 | 149.9 | 100 | 100 |
| 2.5 | 2.90 | Floated material | 0.3 | 3.6 | 49.1 | 540.4 | 1 | 13 |
| | | Non-floated material | | 96.4 | 326.7 | 130.6 | 99 | 87 |
| | | Feed | | 100.0 | 316.7 | 145.3 | 100 | 100 |

TABLE 2
Example 3 - flotation tests with various surfactant collectors, pulp and
air feed rates, concentration of the collector relative to the pulp, and
at various points of introduction of the collector (pump: at the pump for
recirculating the pulp into the column into which the flotation gas is introduced,
top CL: between the foam-pulp interface and the pulp feed point)

| | | | Collector | | | | |
|---|---|---|---|---|---|---|---|
| | | | concentration | | | | |
| | | | (ppm) | Recovery | | | |
| | | | and place of | yield in | | | Bubble |
| | Ja | Jg | introduction of | froth (%) | | | diameter |
| Reagent | (cm/s) | (cm/s) | the collector | CO₃ | SO₄ | Selectivity | (mm) |
| Oleate | 1.13 | 1.05 | 11.8/pump | 21 | 77 | 12.7 | 0.84 |
| Oleate | 1.13 | 1.14 | 2.8/pump | 11 | 78 | 28.9 | 0.86 |
| Oleate | 1.13 | 1.20 | 5.9/pump | 10 | 71 | 23.0 | 0.96 |
| Oleate | 1.13 | 1.07 | 2.8 + 2.8/pump | 13 | 81 | 30.2 | 0.77 |
| Oleate | 1.13 | 1.00 | 5.9 + 5.9/pump | 19 | 94 | 64.6 | 0.70 |
| Oleate | 1.13 | 0.80 | 3.0/pump | 6 | 76 | 48.4 | 0.78 |
| Oleate | 1.13 | 0.89 | 3.0/top CL | 16 | 94 | 82.5 | 0.80 |
| Oleate | 1.13 | 0.89 | 3.0/top CL | 14 | 93 | 76.3 | 0.81 |
| Oleate | 1.13 | 0.54 | 1.4/top CL | 13 | 90 | 62.7 | 0.56 |
| Oleate | 1.22 | 0.75 | 1.7/top CL | 16 | 87 | 33.5 | / |
| Oleate | 1.13 | 0.67 | 0.9/top CL | 8 | 84 | 57.5 | 0.60 |
| Oleate | 1.26 | 0.85 | 0.8/top CL | 6 | 86 | 95.2 | / |
| Oleate | 0.92 | 0.87 | 1.1/top CL | 8 | 88 | 83.9 | / |
| Sodium laurate | 1.13 | 0.89 | 2.8/pump | 12 | 82 | 32.5 | 0.81 |
| Sodium dodecyl | 1.13 | 0.82 | 5.6/pump | 15 | 76 | 18.3 | 0.66 |
| sulfate | | | | | | | |
| Sodium dodecyl | 1.13 | 0.94 | 11.8/pump | 20 | 72 | 10.6 | 0.76 |
| sulfate | | | | | | | |
| Sulfosuccinamate | 1.13 | 0.65 | 7.0/pump | 22 | 83 | 17.7 | 0.57 |
| CA540 | | | | | | | |
| Sulfosuccinamate | 1.13 | 0.65 | 14.0/pump | 46 | 84 | 6.0 | 0.55 |
| CA540 | | | | | | | |
| Sulfosuccinamate | 1.13 | 0.65 | 39.0/pump | 66 | 90 | 4.7 | 0.55 |
| CA540 | | | | | | | |

TABLE 3
Example 4 - flotation tests at various air feed
rates and with mixtures of surfactant collectors:

| | | | | Recovery | | | |
|---|---|---|---|---|---|---|---|
| | | | Collector | yield in | | | Bubble |
| | Ja | Jg | concentration | froth (%) | | | diameter |
| Reagent | (cm/s) | (cm/s) | (ppm) | CO₃ | SO₄ | Selectivity | (mm) |
| Sulfosuccinamate | 1.13 | 0.65 | 14 + 14 | 37 | 78 | 6.1 | 0.58 |
| CA540 + Oleate | | | | | | | |
| Sodium dodecyl | 1.13 | 0.80 | 5.9 + 5.9 | 7 | 62 | 21.4 | 1.20 |
| sulfate + sodium | | | | | | | |
| laurate | | | | | | | |
| Sodium laurate + | 1.13 | 0.94 | 2.8 + 2.8 | 9 | 84 | 53.5 | 0.85 |
| ISF 12 | | | | | | | |
| Oleate + ISF 12 | 1.13 | 0.77 | 7 + 7 | 10 | 84 | 44.9 | 0.77 |
| Oleate + ISF 12 | 1.13 | 0.89 | 15 + 15 | 16 | 78 | 18.7 | 0.87 |
| Oleate + ISF 12 | 1.13 | 1.14 | 3 + 3 | 6 | 79 | 60.0 | 0.87 |
| Oleate + ISF 12 | 1.13 | 1.02 | 6 + 6 | 12 | 76 | 23.3 | 0.76 |
| Oleate + ISF 16 | 1.13 | 0.70 | 11 + 11 | 14 | 46 | 5.5 | 0.89 |
| Oleate + ISF 16 | 1.13 | 0.89 | 11 + 11 | 26 | 66 | 5.5 | 0.75 |
| Oleate + ISF 16 | 1.13 | 0.85 | 3 + 3 | 3 | 55 | 42.5 | 1.15 |

In the case where the disclosure of patents, patent applications and publications which are incorporated herein by reference might give rise to a conflict in the understanding of a term, rendering it unclear, the present specification prevails.

1. A method for separating a suspension containing gypsum granules, calcium carbonate granules and an aqueous solution, wherein the aqueous solution comprises at least one sodium salt and wherein the aqueous solution has a sodium ion concentration of at least about 3 g/L, said method comprising:
a step of separation of said suspension by flotation using a collector for the gypsum granules, the collector comprising at least one heteropolar organic surfactant of formula RX, in which:
R denotes a hydrocarbon-based chain comprising from 2 to 50 carbon atoms and the hydrocarbon-based chain is selected from the group consisting of: a saturated linear alkyl chain, an unsaturated linear alkyl chain, a saturated branched alkyl chain, and an unsaturated branched alkyl chain; and
X denotes at least one ionizable group selected from the group consisting of: a carboxylic group, a sulfonate group, a sulfate group, a phosphonate group, a phosphate group, and a hydroxamate group.

2. The method as claimed in claim 1, wherein the heteropolar organic surfactant of formula RX is selected from the group consisting of: a sodium or potassium oleate, a sodium or potassium alkylsulfonate, a sodium or potassium alkyl sulfate, a sodium or potassium sulfosuccinamate, and a mixture thereof.

3. The method as claimed in claim 1, wherein the heteropolar organic surfactant of formula RX is a sodium or potassium oleate.

4. The method as claimed in claim 1, wherein the collector also comprises a nonionic surfactant.

5. The method as claimed in claim 1, wherein the calcium carbonate granules and the gypsum granules have a particle size distribution such that at least 90% by weight of the particles have a diameter of less than 150 μm.

6. The method as claimed in claim 1, wherein the amount of gypsum granules or of calcium carbonate granules reported per unit volume of said suspension is at least 10 kg/m³.

7. The method as claimed in claim 1, wherein the suspension contains a weight ratio between gypsum granules and calcium carbonate granules of between 1:3 and 3:1.

8. The method as claimed in claim 1, wherein the suspension has a pH of at least 5.

9. The method as claimed in wherein the suspension has a pH of not more than 13.

10. The method as claimed in claim 1, wherein the aqueous solution also comprises at least one calcium salt, and wherein the aqueous solution has a calcium ion concentration of at least about 0.5 g/L.

11. The method as claimed in claim 1, wherein the step of separation by flotation is performed with a flotation cell of mechanical stirring type, and wherein the flotation cell has a mean surface speed of gas at least 0.1 cm/s.

12. The method as claimed in claim 11, wherein the mean surface speed of gas in the flotation cell is not more than 5.0 cm/s.

13. The method as claimed in claim 1, wherein the suspension containing said gypsum granules, said calcium carbonate granules and said aqueous solution is obtained by:
a) adding milk of lime to a saline solution comprising at least 0.5 g of sulfate ions per liter, and
b) carbonatation of all or part of the milk of lime with carbon dioxide.

14. The method as claimed in claim 1, wherein the suspension containing said gypsum granules, said calcium carbonate granules, and said aqueous solution is obtained by reaction of a milk of lime comprising at least one sodium salt, or of a mixture of milk of lime and of a calcium carbonate brew comprising at least one sodium salt with acidic fumes derived from combustion of a sulfurous organic compound.

15. A method for using the calcium carbonate granules or gypsum granules derived from the method as claimed in claim 1, in cement works, or in civil engineering, or in road engineering, or for the manufacture of building materials, or the manufacture of plaster boards or slabs, or the manufacture of road granulates, or the manufacture of filling materials for filling underground cavities.

16. The method as claimed in claim 11, wherein the step of separation by flotation is performed with a flotation column.

17. The method as claimed in claim 11, wherein the mean surface speed of gas in the flotation cell is not more than 3.0 cm/s.

18. The method as claimed in claim 11, wherein the mean surface speed of gas in the flotation cell is at least 0.2 cm/s and not more than 3 cm/s.
